(19) United States
(12) Patent Application Publication
(10) Pub. No.: US 2020/0295574 A1
(43) Pub. Date: Sep. 17, 2020

(54) DISTRIBUTION SYSTEMS USING INCONGRUENT LOAD IMBALANCE RESPONSE

(71) Applicants: Mitsubishi Hitachi Power Systems Americas, Inc., Lake Mary, FL (US); Mitsubishi Hitachi Power Systems, Ltd., Yokohama-Shi (JP)

(72) Inventor: Lisa Batsch-Smith, Orlando, FL (US)

(21) Appl. No.: 16/606,948

(22) PCT Filed: Dec. 8, 2017
(86) PCT No.: PCT/US2017/065323

§ 371 Date: Oct. 21, 2019

(51) Int. Cl. H02J 3/46; H02J 13/00; H02J 3/38; G05B 19/042

(52) U.S. Cl. CPC H02J 3/46; H02J 13/00002; G05B 2219/2639; G05B 19/042; H02J 3/381

(57) ABSTRACT

A method of controlling operation of a first power plant in response to changing power grid conditions can comprise: receiving a power-plant-specific power assignment from an operator of a grid system, monitoring an operating frequency of the power grid relative to a control frequency, operating at least one power generator of the first power plant at the control frequency to provide a local power output to meet the power-plant-specific power assignment under steady state conditions, detecting a load imbalance from the power grid wherein the operating frequency and the control frequency are different, and operating the at least one power generator to provide a power-plant-specific imbalance response wherein the local power output is adjusted based on a power-plant-specific-trait of the first power plant relative to a second power plant working with the operator.

### TECHNICAL FIELD

This document pertains generally, but not by way of limitation, to electrical power distribution systems that can receive power from multiple power plants, including those operating gas turbine engines. More specifically, but not by way of limitation, the present application relates to control systems for electrical power distribution systems and power plants having a load imbalance response to changing grid conditions.

### BACKGROUND

Power plants typically supply power to a grid system within a distributed network where voltage is provided at a constant amplitude or magnitude. The grid system is managed to maintain frequency regulation, such as at a control frequency of, for example, 60 Hertz (Hz), so that the frequency and voltage magnitude maintain stability across a broad range of power input and load conditions. Each power plant can separately provide power to the grid system using a controlled frequency that can coincide with the control frequency. Put another way, each power plant is expected to contribute power to meet the demand such that the grid system operates with the desired degree of frequency regulation, such as at the control frequency. Typical loading on the grid system will not vary enough to cause the system frequency to change from the control frequency. However, when the load on the grid system changes sufficiently, such as during a load imbalance event, the system frequency will change from the control frequency. For example, when the grid system suddenly becomes heavily loaded, the system frequency will drop as each power plant correspondingly becomes more heavily loaded. That is, the additional load on each electrical generator will cause the generator to slow down. The frequency of a synchronous generator is governed by Equation [1].

$$F = \frac{P N}{120} \qquad Equation [ 1 ]$$

In Equation [1], F is frequency in Hertz (Hz), P is the number of poles in the generator, and N is the speed of the generator in revolutions per minute (RPM). Some power plants operate gas turbine engines as prime movers to operate electrical generators. In order to produce the additional power required by the grid system, a control system for each power plant can provide additional fuel to gas turbine engine combustors according to a predetermined schedule corresponding to a prescribed “droop response.” As additional power is provided to the grid system to accommodate the increased power demand, the speed (N) of the prime mover (e.g. the rotational shaft speed of a gas turbine engine) driving the generator and the grid frequency will increase back to a desired system frequency (F), which can correspond to the control frequency.

In order to distribute the additional demand placed on the grid system during a load imbalance event, power plant control systems operate under a conventional response plan. For example, each electrical generator will respond to a percentage drop in the control frequency by increasing its output a fixed amount. This is commonly referred to a “droop response.” Droop response can be described as a change in design speed for a 100% governor action. For a 4% droop response, a generator will increase power output 25% for each 1% drop in the control frequency. Thus, a larger or more robust droop response level comprises a smaller droop response percentage as compared to, for example, a typical 4% droop response. Likewise, a smaller or less robust droop response level comprises a larger droop response percentage as compared to, for example, a typical 4% droop response. Droop response is typically regulated by the North American Electric Reliability Corporation (NERC) so that all power plants respond to a load imbalance in the same manner.

Examples of controlling power production in power grids are described in U.S. Pat. No. 5,555,719 to Rowen et al.; U.S. Pub. No. 2009/0112374 to Kirchhof et al.; and U.S. Pub. No. 2014/0060065 to Sweet et al.

### Overview

The present inventors have recognized, among other things, that a problem to be solved can include ineffective or inefficient droop responses placed on various power plants within a grid system and various electrical generators within a power plant. For example, each power plant in a grid system and each generator within a power plant is typically expected to provide the same droop response during a load imbalance event. Uniform droop responses can give rise to ineffectiveness at the power plant level and at the individual generator level due to, for example, operational, electrical, administrative, productive, mechanical, economic and financial differences between power plants and generators. Furthermore, inefficiencies can result at the grid level wherein inadequate or ineffective droop responses can result in an overshoot where excess capacity is produced or can even result in load shedding situations. Extreme or uncontrolled load shedding can result in rolling or full blackout conditions or lead to control scheme oscillations.

The present subject matter can help provide a solution to this problem, such as by increasing droop response effectiveness by allowing power plants to react differently to a load imbalance event with different droop responses based on one or more various power-plant-specific traits, such as the percentage of total grid demand provided by a power plant, the maintenance history or schedule of a power plant, the location of the power plant relative to end users of the power, and the power generation type of the power plant. Droop response effectiveness can be increased by allowing the grid and power plants to take advantage of differences in the aforementioned power-plant-specific traits. Power-plant-specific droop responses can reduce overshoot thereby reducing oscillations, and load shedding situations.

In an example, a method of controlling an imbalance response in a power grid that can comprise a first power plant and a second power plant, the method can comprise: monitoring operation of the first power plant while operating at a first level to provide a first power output, monitoring operation of the second power plant while operating at a second level to provide a second power output, monitoring load demand from the power grid operating at a steady state condition, detecting a load imbalance on the power grid that causes a deviation from the steady state condition, and issuing incongruent load imbalance instructions to the first power plant and the second power plant to provide a load imbalance response to change the first power output and the second power output to reduce the deviation from the steady state condition depending on a power-plant-specific trait of each of the first power plant and the second power plant.

In another example, a method of controlling operation of a first power plant in response to changing power grid conditions can comprise: receiving a power-plant-specific power assignment from an operator of a grid system, monitoring an operating frequency of the power grid relative to a control frequency, operating at least one power generator of the first power plant at the control frequency to provide a local power output to meet the power-plant-specific power assignment under steady state conditions, detecting a load imbalance from the power grid wherein the operating frequency and the control frequency are different, and operating the at least one power generator to provide a power-plant-specific imbalance response wherein the local power output is adjusted based on a power-plant-specific-trait of the first power plant relative to a second power plant working with the operator.

In an additional example, a control system for operating a power plant can comprise: a power plant controller for controlling at least one power generator at a facility, the power plant controller can comprise: a power generator interface for providing control input signals to the at least one power generator to control output of at least one electrical generator, a grid interface for receiving a control frequency at which a power grid is to be operated, and a current operating frequency of the power grid, and memory having stored therein power-plant-specific data for the power plant relative to other power plants of the power grid, wherein the power plant controller is configured to adjust a droop response of the power plant incongruently relative to the other power plants based on the power-plant-specific data in response to the current operating frequency deviating from the control frequency.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 is a schematic diagram illustrating a power system including multiple electrical generator units within multiple power plants providing output to a distributed grid network.

FIG. 2 is a diagram illustrating a first power plant and a second power plant having power-plant-specific traits comprising demand percentage and maintenance state.

FIG. 3 is a diagram illustrating a third power plant and a fourth power plant having power-plant-specific traits comprising distance from end users and generation type.

FIGS. 4A and 4B are graphs illustrating conventional frequency or droop response and an incongruent frequency or droop response of the present application, respectively.

FIGS. 5A and 5B are graphs illustrating conventional load response and an incongruent load response of the present application, respectively.

FIG. 6 is a schematic diagram illustrating components of controllers for operating the power system and power plants of FIG. 1.

FIG. 7 is a line diagram illustrating steps of a method for providing incongruent load imbalance responses for power plants of a power grid.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

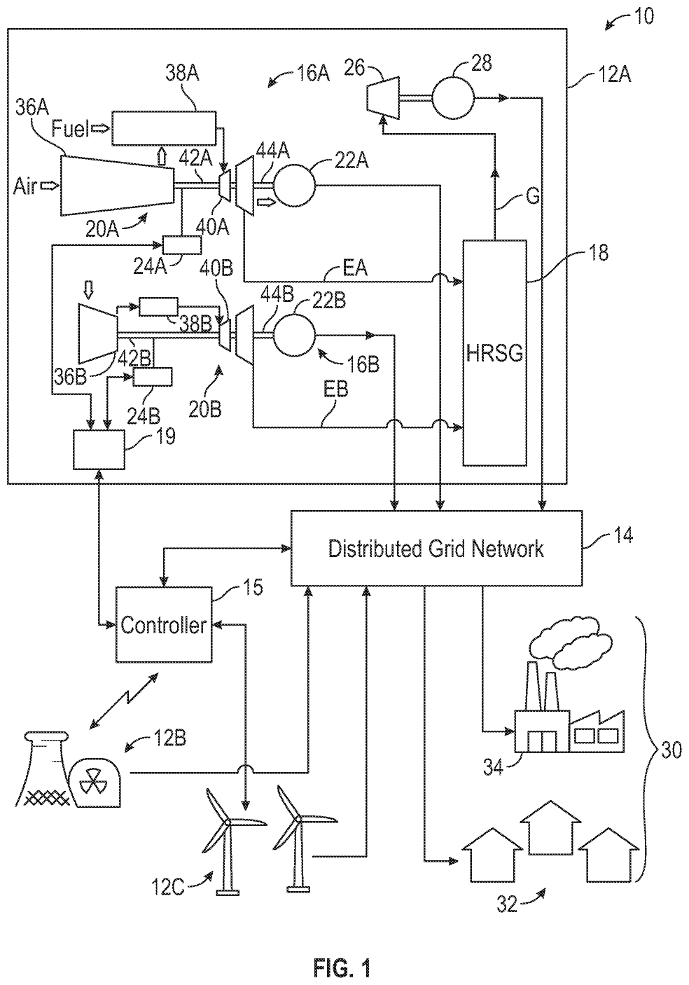

FIG. 1 is a schematic diagram of power system 10 illustrating power plant 12A, power plant 12B and power plant 12C providing electrical power to distributed grid network (DGN) or “grid” 14, which can include controller 15. First power plant 12A can include first generator unit 16A, second generator unit 16B, heat recovery steam generator (HRSG) 18, and controller 19. First generator unit 16A can comprise first gas turbine 20A, first electrical generator 22A and first engine controller 24A, such as a Distributed Control Systems (DCS) device. Second generator unit 16B can comprise second gas turbine 20B, second electrical generator 22B and second engine controller 24B, such as a DCS. HRSG 18 can be operatively coupled to steam turbine 26, which can be connected to electrical generator 28. DGN 14 can be configured to deliver power from electrical generators 22A, 22B and 28 to end users 30, which can include residential housing units 32 and factory 34, for example.

The present application is directed to systems and methods for controlling power delivery from power plants 12A, 12B and 12C to DGN 14 during load imbalance situations, whether comprising a short term transitory imbalance or a long term new output level. A short term load imbalance can occur such as when another power plant, such as one of power plants 12B or 12C goes offline, particularly in a sudden fashion, or when factory 34 goes online, particularly in a sudden fashion. For example, controller 19 can cooperate with controller 15 to operate generator units 16A and 16B to more effectively provide power to end users 30 during the load imbalance based on a power-plant-specific trait of power plant 12A relative to power-plant-specific traits of power plants 12B and 12C. In various scenarios, system effectiveness can be achieved by operating power plant 12A most operationally efficient (also herein referred to as a “contemporaneous efficiency state”), including both productive and economical efficiencies, relative to operational efficiencies of power plants 12B and 12C based on the power-plant-specific traits. In various applications, power system 10 can be operated most effectively by operating power plant 12A with a different droop response than power plants 12B and 12C, which can be operated at a typical droop response such as 4%, in response to a load imbalance in system 10. While an embodiment of the disclosure has been described with turbines 20A, 20B, 26 connected individually to generators 22A, 22B, 28, it will be appreciated that the scope of the disclosure is not so limited, and shall include other arrangements of turbines and generators, such as to couple all turbines to a single generator, or to couple the gas turbines 20A, 20B to a single generator, etc., for example.

As will be discussed below in greater detail, if the load demand upon DGN 14 is decreasing, and requires a reduction in power generation, the power output of the less effective power plant can be decreased more during the transition period (the time it takes for system 10 to adjust to the load imbalance situation whether comprising a short term transitory imbalance or a long term new output level) than the power output of the more effective power plant. Likewise, if the load demand upon DGN 14 is increasing, and requires an increase in power generation, the power output of the more effective power plant can be increased more during the transition period than the power output of the less effective power plant. The power plant effectiveness can be based on the power-plant-specific traits discussed herein. For example, controller 19 can operate power plant 12A at a higher droop response percentage (e.g., 5%) than the typical droop response percentage (e.g., 4%) that power plants 12B and 12C are expected to operate at if power plant 12A is, at the time of the load imbalance, operating to provide a greater percentage of the demand for DGN 14. That is, first power plant 12A will be less responsive and provide less power to DGN 14, thereby achieving greater system effectiveness by reducing a likelihood of control system overshoot, which can result in undesirable control oscillation(s).

As described in greater detail below, controller 19 can operate power plant 12A with different droop responses based on a variety of power-plant-specific traits such as, percentage of total grid demand being supplied by the power plant, the distance of the power plant from consumers of power or customers of a grid system, the type of power generators being used at the power plant and the associated responsiveness of the power generators, and the online capacity of the power plant, e.g. the percentage of power generators at the power plant not down for maintenance.

As is known in the art, gas turbines 20A and 20B operate by compressing air with a compressor, and burning fuel within the compressed air to generate high energy gases that pass through a turbine that produces rotational shaft power to drive an electrical generator. Gas turbine 20A can include compressor 36A, combustor 38A, turbine 40A, turbine shaft 42A and output shaft 44A. Gas turbine 20B can include compressor 36B, combustor 38B, turbine 40B, turbine shaft 42B and output shaft 44B. In some non-limiting examples of embodiments of the present application, gas turbines 20A and 20B are constructed in the same manner, e.g., are the same model or have the same capacity.

Engine controllers 24A and 24B can control the amount of fuel that is delivered to combustors 38A and 38B, thereby controlling the power output of gas turbines 20A and 20B and thus influence the rotational speed of turbine shafts 42A and 42B. Engine controllers 24A and 24B can operate the output of gas turbines 20A and 20B such that the speed of turbine shafts 42A and 42B operate at a control frequency of system 10 under steady state operating conditions.

Exhaust gas EA and EB of gas turbines 20A and 20B, respectively, can be directed to HRSG 18. HRSG 18 can utilize the hot exhaust gas EA and EB to produce gas G, such as steam, for driving turbine 26.

Electrical output of generators 22A and 22B and electrical generator 28 can be provided to DGN 14. Interface of generator units 16A and 16B with DGN 14 can be controlled by controller 19, which can interface directly with engine controllers 24A and 24B.

Grid 14 can operate under a frequency control regime. During steady state operation, power plants 12A, 12B and 12C provide power to grid 14 at a control frequency, such as 60 Hertz. End users 30 can also operate at various levels, thereby creating a total load demand upon the DGN 14 that can change. Thus, controller 15 can distribute the total load demand amongst power plants 12A, 12B and 12C, which can then operate to provide their assigned share of the load demand, operating with a bias toward the control frequency. Each of power plants 12A, 12B and 12C can internally determine how to generate their share of the total load demand. For example, power plant 12C can operate some or all of the total number of wind turbines in power plant 12C. Also, power plant 12A can determine to operate gas turbines 20A and 20B to each equally divide the share of power that they produce as part of power plant 12A. Thus, under steady state operating conditions, end users 30 place a total load demand on grid 14, and controller 15 allocates the total load demand to power plants 12A, 12B and 12C.

End users 30, or consumers or customers, typically operate within a reasonably predictable operating band for any point in time such that small changes in the total power demand do not produce significant changes in the operation of power plants 12A, 12B and 12C. That is, for example, controller 15 can be programmed to estimate total demand from end users 30 based on seasonal, weather, economic, demographic and historical usage data to within a known operating band. However, sometimes load imbalances can be produced if the total load demand rapidly changes, either upward or downward. Also, the share of the total load demand on each of power plants 12A, 12B and 12C can rapidly change in the event one of power plants 12A, 12B and 12C goes offline, or has a temporary change in power output. In either of these load spike scenarios, controller 15 typically requests each of power plants 12A, 12B and 12C respond in an appropriate manner such that additional loading is shared either equally or proportionally. Regardless, controller 15 expects each of power plants 12A, 12B and 12C to react in a particular manner in response to a load imbalance. For example, in the event of an unexpected load increase, controller 15 can expect a typical 4% droop response from each of power plants 12A, 12B and 12C, assuming each is capable of such response. For example, power plant 12C may not be capable of such a response given wind conditions.

In other embodiments, a load imbalance may result when controller 15 determines that the operating point for the predictable operating band should be reset to a higher or lower output level. For example, controller 15 may request lower collective output from power plants 12A, 12B and 12C during night time as compared to day time due to lower demand. As such, a load imbalance may occur within DGN 14 during a load down (or converse, load up) event.

Aspects of the present application are directed to each power plant 12A, 12B and 12C reacting incongruently, e.g, asymmetrically or differently, to an imbalance response called for by grid 14 via controller 15, for example. Controller 15 can coordinate different droop responses from power plants 12A, 12B and 12C, or controllers 19 can, with information pre-provided by controller 15, individually manage how to provide the imbalance response desired by controller 15. For example, if controller 15 desires a total 4% droop response from DGN 14, controller 15 can request (or power plants 12A, 12B and 12C can individually determine) that power plant 12A provide a 3% droop response, power plant 12B provide a 4% droop response, and power plant 12C provide a 5% droop response, with the droop response assignments being determined based on the power-plant-specific traits identified above, so that controller 15 and DGN 14 still receive the desired imbalance response, e.g., the 4% droop response. The power-plant-specific droop responses can also result in the total droop response being above or below the desired droop response of controller 15. The incongruent droop responses can be determined based on the power-plant-specific traits described herein.

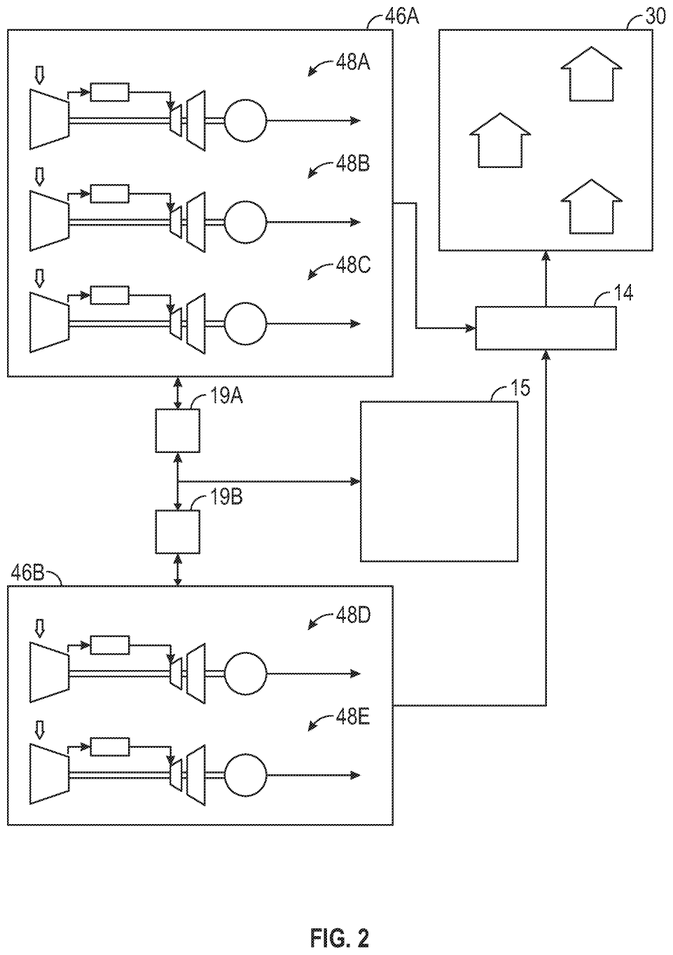

FIG. 2 is a diagram illustrating first power plant 46A and second power plant 46B having power-plant-specific traits comprising demand percentage and maintenance state. Power plants 46A and 46B are in communication with grid controller 15 via power plant controllers 19A and 19B, respectively. Power plants 46A and 46B are configured to provide power to end users 30 via DGN 14.

Power plant 46A can be configured as a 3-on-1 combined cycle plant where gas turbines 48A, 48B and 48C provide exhaust to a single steam turbine (not illustrated in FIG. 2) similar to turbine 26 (FIG. 1). Power plant 46B can be configured as a 2-on-1 combined cycle plant where gas turbines 48D and 48E provide exhaust to a single steam turbine (not illustrated in FIG. 2) similar to turbine 26 (FIG. 1). Note that although power plants 46A and 46B are configured as having multiple gas turbines and associated electrical generators, power plants can include only a single electric generator, whether turbine powered or powered by another source. The various droop responses, incongruent load imbalance responses and power-plant-specific traits discussed herein are applicable to power plants having one or at least one electrical generators.

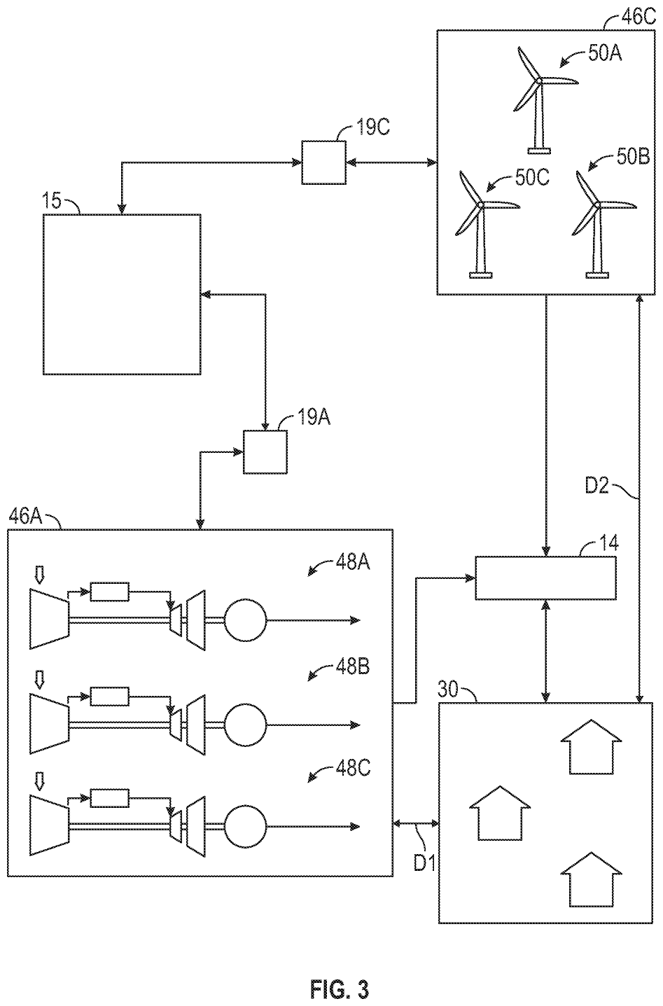

In various examples, power plants 46A and 46B can be configured to provide different percentages of the total demand end users 30 place on DGN 14. For example, power plant 46A can be configured to provide a greater percentage of the total demand. For discussion purposes, power plant 46A can provide 60% of the total grid demand of end users 30 while power plant 46B can provide 40%. Additionally, other power plants can be connected to DGN 14, such as power plant 46C of FIG. 3, but power plant 46A can still generate a larger percentage of the total grid demand relative to power plant 46B. Consider a load imbalance event, during which power plants 46A and 46B can be configured to react incongruently, or differently, rather than each acting identically as is typical. For example, in a sudden partial power outage event where a third power plant, such as power plant 46C of FIG. 3 goes offline, it would be appreciated that use of the same droop response for the (relatively) larger power plant 46A and smaller power plant 46B could result in a reactionary over-production of power, also known as an overshoot condition, because power plant 46A is configured to provide more power to end users 30 than power plant 46B, and is likely to be slower in responding.

In an embodiment, a likelihood of such an overshoot may be reduced by increasing a droop response percentage of power plant 46A. By increasing its droop response percentage from the typical 4% to a 5% droop response, power plant 46A can thereby provide a slower response and reduce the likelihood of an overshoot of power supply, which is inefficient and ineffective.

Further, power plant 46B can maintain a 4% droop response because, for example, increasing the load imbalance response on a power plant providing a small percentage of the total power may overburden the power plant causing inefficiencies and may be ineffective in meeting the load imbalance response. The maintained response of the relatively smaller power plant, which is also likely to be relatively faster in responding, is likely to provide the requested change in power demand that can expedite a return to the nominal control frequency without encountering the overshoot condition. Thus, in some instances, if the total contribution of power plant 46B is small, it still may be desirable to decrease the droop response percentage to prevent inefficient operation of the larger contributing power plant, even if power plant 46B is driven to maximum contribution. Larger units tend to be much more efficient when allowed to remain at a steady state load condition. They are also traditionally slower to respond due to momentum and inertia and such other laws of physics. So, in this case, the smaller unit might be driven up even to maximum contribution if it allows overall operations to retain the efficiency and stability of the larger unit and let the smaller units contribute their own and the portion that would be provided by the larger unit in order to provide a more economical event response with all of their tools available.

In various examples, grid controller 15 may provide instantaneous droop response instructions to power plant controllers 19A and 19B for power plants 46A and 46B based on the monitored percentage of total grid demand being placed on each of power plants 46A, 46B by end users 30 via DGN 14. In other examples, controllers 19A and 19B may be provided with information from controller 15 to allow controllers 19A and 19B to react independently. For example, control 15 can provide controllers 19A and 19B with the percentage of total power demand being generated by each power plant on DGN 14.

In various examples, power plants 46A and 46B can be configured to provide incongruent, e.g., asymmetric or different, droop responses based on conditions of operating assets within or near each of power plants 46A and 46B. For example, power plants 46A and 46B may be operating in different maintenance states where one or more of gas turbines 48A-48D may be down for repair. For example, power plant 46A may be operating with gas turbine 48C down for repair. In such a scenario, if power plant 46B goes offline, controller 19 for power plant 46A may adjust the droop response for gas turbines 48A and 48B relative to a droop response that would occur if all three gas turbines 48A-48C were operating. For example, instead of increasing the droop response percentage as discussed above, gas turbines 48A and 48B could maintain a 4% droop response to prevent both overshoot and overburdening.

For example, power plants operate on maintenance intervals and may shut down annually or every eighteen months for maintenance. This can be due to the wear on the components and portions of the system will be replaced as the maintenance activity; e.g., fuel injectors, thermal barrier coatings and the like can be checked and repaired. The overall efficiency of the unit can decrease while operating with the degraded parts just prior to the maintenance interval. Therefore, we can assume, for example, that power plants 46A and 46B are identical co-operational gas turbines, but with annual maintenance outages occurring in October and April, respectively. If we have frequency events happening in December, the unit that was just serviced in October may be more operationally efficient for the owner per MW produced, due to productive efficiency factors. So, it can be advantageous to favor the most-recently-serviced gas turbine during the droop response.

FIG. 3 is a diagram illustrating first power plant 46A and third power plant 46C having power-plant-specific traits such as distance from end users and generation type. Power plants 46A and 46C are in communication with grid controller 15 via power plant controllers 19A and 19C, respectively. Power plants 46A and 46C are configured to provide power to end users 30 via DGN 14.

Power plants 46A and 46C can be located at different geographic locations relative to end users 30. For example, first power plant 46A can be located distance D1 from end users 30 and third power plant 46C can be located distance D2 from end users 30.

Power plant 46A can be configured as a 3-on-1 combined cycle plant where gas turbines 48A, 48B and 48C provide exhaust to a single steam turbine (not illustrated in FIG. 2) similar to turbine 26 (FIG. 1). Power plant 46C can be configured as a wind farm having wind turbines 50A, 50B and 50C.

Incongruent droop response can be determined by determining which of distances D1 and D2 is smaller in order to provide a droop response. For example, if a power plant connected to DGN 14 other than power plants 46A and 46C, such as power plant 46B (FIG. 2) goes offline, whichever of power plant 46A and 46C that is closer to end users 30 can provide a greater load imbalance response, such as by providing a smaller droop response percentage. Thus, because power plant 46A is closer to end users 30 such that distance D1 is smaller than distance D2, power plant 46A can reduce its droop response percentage, such as from the typical 4%, while power plant 46C can maintain a 4% droop response. Power plant 46A thereby provides a more robust droop response that can more rapidly address the power deficit.

Incongruent load response can also be provided by decreasing the droop response percentage of the more responsive of power plants 46A and 46C. For example, power plant 46A, as described above, can comprise a combined cycle gas turbine power plant, while power plant 46C can comprise a wind farm or wind power plant. Combined cycle power plants can be more responsive to changing conditions due to greater control over the power generation process. For example, as discussed herein, power output of gas turbines can be increased by providing more fuel to the combustion process on demand. However, wind turbines 50A-50C of power plant 46C at least in part are dependent on environmental or wind conditions for power production. Thus, power plant 46C cannot always be as responsive as is desired to changing grid conditions. For example, if a power plant connected to DGN 14 other than power plants 46A and 46C, such as power plant 46B (FIG. 2) goes offline, whichever of power plant 46A and 46C has the more responsive power generating type, e.g. the power generating type that can more rapidly increase power output, can provide a greater load imbalance response, such as by providing a smaller droop response percentage. Thus, because power plant 46A is more responsive, power plant 46A can reduce its droop response percentage, such as from the typical 4%, while power plant 46C can maintain a 4% droop response. Power plant 46A thereby provides a more robust droop response that can more rapidly address the power deficit. In certain scenarios, it may even be that power plant 46C is causing the imbalance due to rapidly changing wind conditions.

In other examples, combined cycle gas turbine power plants can be less responsive than simple cycle gas turbine power plants. As such, if power plant 46A were a combined cycle gas turbine power plant and power plant 46C were a simple cycle gas turbine power plant, because power plant 46C is more responsive, power plant 46C can reduce its droop response percentage, such as from the typical 4%, while power plant 46A can maintain a 4% droop response.

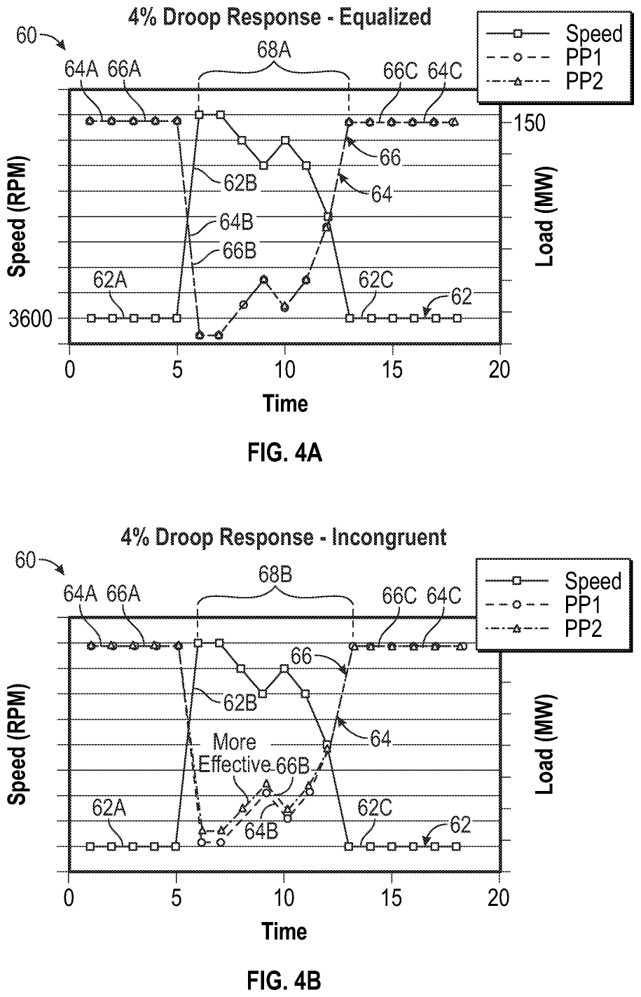

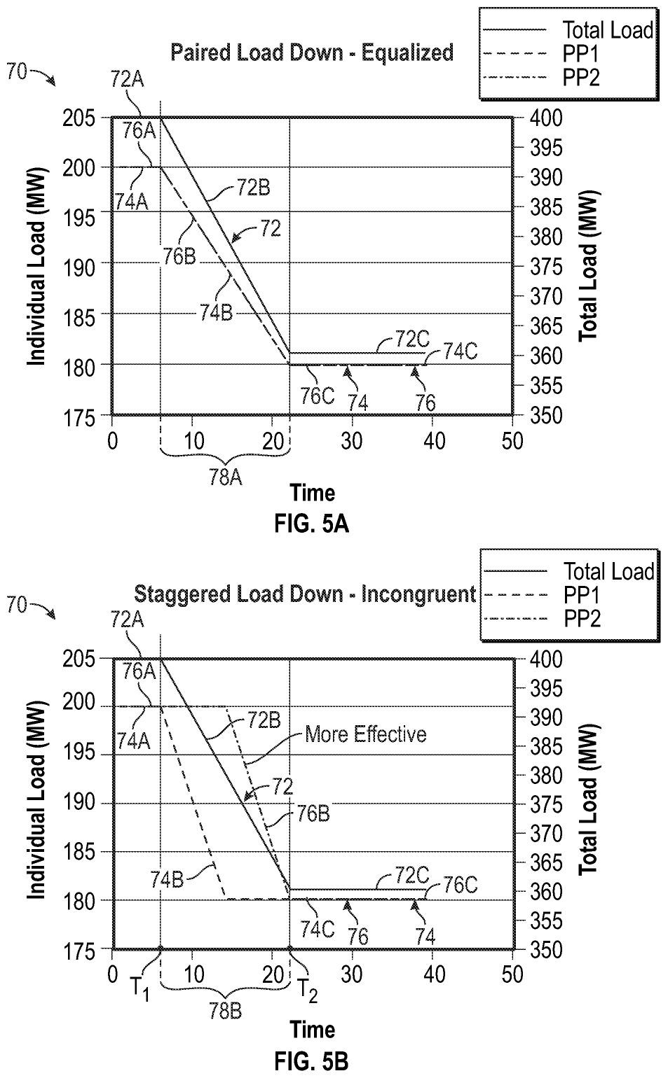

Based on the various power-plant-specific traits described above, such as with respect to FIGS. 2 and 3, controller 15 can determine or be programmed to determine which of power plants 46A, 46B and 46C can be incongruently favored or biased during a load imbalance, which may last for long or short term transition periods. Examples of load imbalance can include a sudden, significant demand drop or demand increase from end users 30, or a sudden output drop from one or more of power plants 12A, 12B and 12C, as is discussed, for example, with reference to FIGS. 4A and 4B. In response to detecting a load imbalance, controller 15 can issue imbalance response instructions to each of power plants 12A, 12B and 12C. For example, controller 19 for power plant 12A can receive the imbalance response and take appropriate action, such as to implement a particular droop response. Another example of a load imbalance can comprise a projected long term change in power demand that might require a load up or load down rebalancing of power generation from power plants 12A, 12B and 12C, as is discussed, for example, with reference to FIGS. 5A and 5B. As such, controller 15 can issue load rebalancing instructions to power plants 12A, 12B and 12C such as in a load down or load up situation where total power to grid 14 is changed for long term durations.

Such evaluation or determination can be implemented automatically, such as using one or more processor circuits coupled to one or more memory circuits or other storage devices. A cost, effectiveness or efficiency function can be established accounting for the various factors mentioned above (e.g., location, responsiveness, power contribution, mechanical or financial constraints), such as implemented using one or more of a look-up-table, an analytical expression (e.g., including various parameters or weighting factors), or other scheme. In an example, inputs to the cost, effectiveness or efficiency function can include one or more of a monitored parameter (e.g., frequency, frequency stability, output power, voltage magnitude) from the power grid to which the power plants 12A, 12B, 12C, 46A, 46B and 36C are coupled, or other parameters such as state information concerning the power plants or their associated prime movers. An output of the cost, effectiveness or efficiency function can include a relative value corresponding to an associated power plant, generator units 16A or 16B, or an associated prime mover. Such a cost value can be used to establish an operating point for the power plant or associated generator units, such as to operate the associated prime movers in an asymmetric manner to perform load imbalance compensation.

FIGS. 4A and 4B are graphs illustrating a conventional frequency or droop response vs. an incongruent frequency or droop response of the present application, respectively, for temporary load imbalance situations. FIGS. 4A and 4B show graph 60 including speed plot 62, first load plot 64 and second load plot 66. For example, speed plot 62 can correspond to the operating speeds of generator units 48A-48C of power plant 46A, and operating speeds of generator units 48D and 48E of power plant 46B, indicated as revolutions per minute (RPM) (which is indicative of the instantaneous grid frequency). Load plots 64 and 66 can correspond to the load (power output) being provided by each of power plants 46A and 46B, such as in megawatts (MW), at a given time. FIGS. 4A and 4B can provide load adjustment for a frequency change that can occur as a result of a load imbalance, such as a temporary change in demand on grid 14.

For example, load plots 64 and 66 indicate that power plants 46A and 46B provide a steady state output of, for example, 150 MW at 3600 RPM, as indicated by segments 64A and 66A. Speed plot 62 can operate at 3600 RPM at segment 62A under steady state operating conditions, such as when grid 14 is operating at the control frequency of 60 Hz. Note, load plots 64 and 66 are described as being the same for simplicity, but do not need to be the same in various examples. During a temporary reduction load imbalance situation, such as a large, short term reduction in power consumption at the factory 34, the load on power plants 46A and 46B can suddenly drop at segments 64B and 66B. The reduced load results in an increase of the instantaneous grid frequency relative to the control frequency, as shown by the spike of speed plot 62 at segment 62B to a level above segment 62A, indicating that each of power plants 46A and 46B are less burdened. In transition zone 68A of FIG. 4A, controller 15 can request that power plants 46A and 46B operate to adjust the load output of each of power plants 46A and 46B until the load returns back to the steady state operating level of 150 MW. Following a load imbalance on grid 14, power plants 46A and 46B will return to the previous steady state operation, such as to return to the control frequency and again each provide 150 MW of output. As shown in FIG. 4A, controllers 19A and 19B can operate power plants 46A and 46B equally, or congruently, so that they provide the same load imbalance response as speed returns to the steady state operating condition at segment 62C. For example, NERC guidelines can provide a droop response instruction, such that power plants 46A and 46B react to the load imbalance with a 4% droop response. FIG. 4A shows power plants 46A and 46B equally sharing the 4% droop response that is provided to grid 14 by power plant 46A and 46B.

Alternatively, during the temporary reduction load imbalance situation, the power output of the less effective or responsive (as may be determined based on one or more of the previously described power-plant-specific traits) power plant of the two power plants 46A and 46B can be reduced more rapidly, as shown in FIG. 4B.

Likewise, the same principle, to bias, favor, or more rapidly increase the power output of the more effective power plant shall apply during an temporary increase load imbalance situation, such as a large, short term increase in power consumption at factory 34, or a sudden increase in temperature resulting in many housing units 32 increasing their use of air conditioners. The droop responses to the short term load imbalance situations may last for a terminable period of time before the droop responses correct the load imbalance and the frequency of the grid is restored to the control frequency.

FIG. 4B shows transition zone 68B where controllers 19A and 19B can operate power plants 46A and 46B incongruently so that they each undergo a different load imbalance response as speed returns to the steady state operating condition at segment 62C. If desired, and consistent with present NERC guidelines, grid 14 may still receive an effective total 4% droop response from power plants 46A and 46B, but the droop response will be incongruently distributed between power plants 46A and 46B. However, in some examples and embodiments, power plants 46A and 46B can act to provide an effective total droop response other than a droop response suggested by present NERC guidelines. As such, the disclosure of the present application can provide a droop response framework as an alternative to guidelines, such as NERC guidelines, that require a certain minimum droop response threshold. That is, the total droop response provided by power plants 46A and 46B may not equal a typical 4% droop response, as would be provided if each power plant were operated with a congruent or symmetric droop response.

In an example embodiment, if power plant 46B is more effective (as determined by the aforementioned power-plant-specific traits such as proximity to users, more responsive in size or power type, or more fully online) than power plant 46A, power plant 46B can be operated to provide more of the load during the time period of transition zone 68B, thus relying less on the relatively ineffective load production from power plant 46A for the transitory time period. In an extreme example, a single power plant can be used to provide one-hundred percent of the droop response, but this may introduce increased operational costs resulting from inefficient operation of a single power plant at elevated rates. Such increased costs would have to be weighed against potential benefits resulting from extreme bias to the most effective power plant.

In either the case of FIG. 4A or FIG. 4B, output of power plants 46A and 46B can be returned to congruent or equal operation, as shown by segments 64C and 66C.

FIGS. 5A and 5B are graphs illustrating conventional load response vs. an incongruent load response of the present application, respectively, for long term readjustment of total load requested by controller 15. FIGS. 5A and 5B show graph 70 including total load plot 72, first load plot 74 and second load plot 76. Total load plot 72 can correspond to the operating loads of power plants 46A and 46B, indicated as megawatts (MW). Load plots 74 and 76 can correspond to the load being provided by each of power plants 46A and 46B, such as in megawatts (MW), at a given time, respectively. Note, load plots 64 and 66 are described as being the same for simplicity, but do not need to be the same in various examples. Load plot 72 is offset on the Y axis to improve visibility by avoiding overlap with load plots 74 and 76. FIGS. 5A and 5B can illustrate a load adjustment, or load down imbalance response, for a load change that can occur as a result of a load imbalance, such as a change in demand on grid 14. For example, load on grid 14 can suddenly drop when factory 34 goes offline resulting in a long term change in power demand. Additionally, weather or other conditions can cause controller 15 to adjust the baseline operating output of power plants 12A, 12B and 12C to account for environmental temperature increases or nighttime operating conditions that can necessitate longer term adjustment of power output versus as compared to a short term droop response. In a load down imbalance response, output of the less effective (as determined by the aforementioned power-plant-specific traits such as proximity to users, more responsive in size or power type, or more fully online) gas turbine can be more rapidly reduced, as shown in FIG. 5B. Likewise, controllers 19A and 19B can operate power plants 46A and 46B to respond to a load up imbalance response by favoring the more effective power plant, based on one or more power-plant-specific traits.

For example, load plots 74 and 76 indicate that power plants 46A and 46B provide a steady state output of, for example, 200 MW, as indicated by segments 74A and 76A. Total load plot 72 shows a corresponding 400 MW output at segment 72A under steady state operating conditions. The load requirement of the grid 14 can suddenly drop at time T1 during a load imbalance situation. Accordingly, the demand on power plants 46A and 46B can also drop, such that segments 74B and 76B decline in transition zone 78A. Total load plot 72 correspondingly drops at segment 72B. In transition zone 78A of FIG. 5A, controllers 19A and 19B can operate power plants 46A and 46B to adjust the load output of each of power plants 46A and 46B until the total load drops to the new demand of 360 MW. As shown in FIG. 5A, controllers 19A and 19B can operate power plants 46A and 46B equally, or congruently, so that they undergo the same transition, indicated by segments 74B and 76B, as output is adjusted to meet the subsequent new steady state operating condition at segment 72C. FIG. 5A shows power plants 46A and 46B equally sharing the 40 MW drop by reducing the output of each equally 20 MW, as shown by segments 74C and 76C.

FIG. 5B shows transition zone 78B where controller 15 can operate power plants 46A and 46B incongruently so that they undergo different load reductions to transition to the new steady state operating condition at segment 72C. For example, if power plant 46B is more effective than power plant 46A, power plant 46B can be operated to provide more of the load during time period of transition zone 78B, thus relying less on the relatively ineffective load production from power plant 46A for a transitory period of time. As discussed above, the load up or load down imbalance response for each power plant can be different to achieve an operational benefit that can be weighed against any operational cost.

After controller 15 for grid 14 has accounted for any load imbalance on grid 14, power plants 46A and 46B will operate at the new steady state operation, such as by providing 360 MW of output. In either the case of FIG. 5A or FIG. 5B, output of power plants 46A and 46B can be returned to congruent or equal operation following the transition period 78A, 78B.

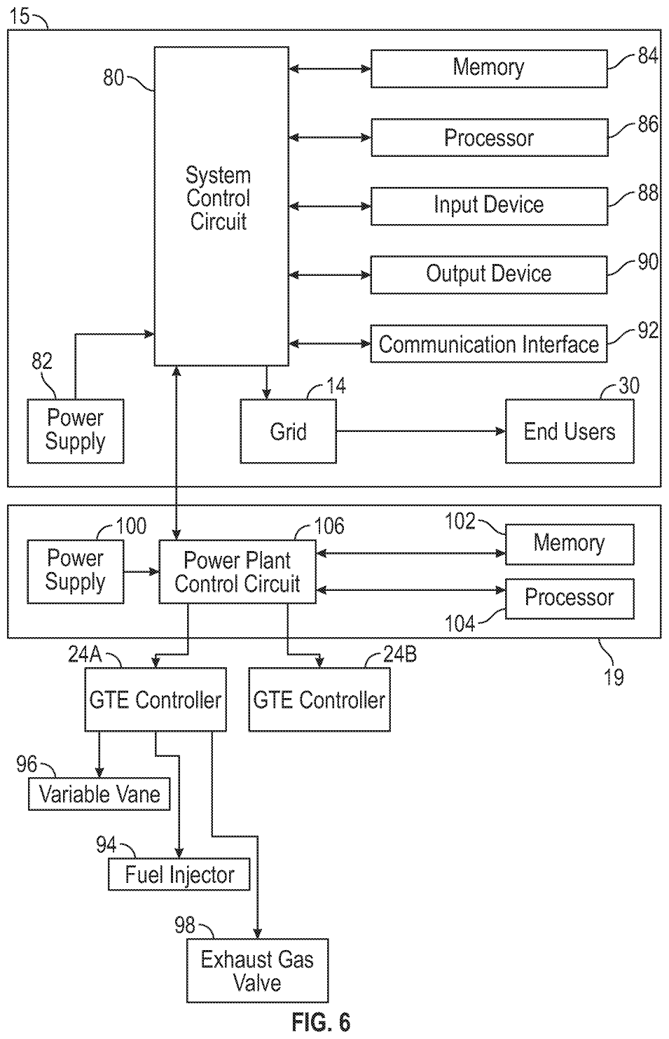

FIG. 6 is a schematic diagram illustrating components of controller 15 for operating power system 10 and power plant controller 19 for operating generator units 16A and 16B of FIG. 1. Controller 15 can include circuit 80, power supply 82, memory 84, processor 86, input device 88, output device 90 and communication interface 92. Controller 15 can be in communication with grid 14, which can provide power to end users 30. Controller 15 can also be in communication with power plant controller 19, which can be in communication with one or more gas turbine engine controllers, such as engine controllers 24A and 24B. Engine controllers 24A and 24B can be in communication with gas turbines 20A and 20B, respectively, to control operation of each turbine. For example, engine controller 24A can be configured to control the combustion process in combustor 38A, which can alter the power output of gas turbine 20A to influence the speed of turbine shaft 42A and the flow of exhaust gas EA to HRSG 18 (FIG. 1). To that end, engine controller 24A can be configured to operate one or more fuel injectors 94, variable vanes 96 and exhaust gas valve 98 for gas turbine 20A. Engine controller 24B can also control similar parameters and components of gas turbine 20B, but description and illustration is omitted with reference to FIG. 6 for brevity.

Power plant controller 19 and engine controllers 24A and 24B can also include various computer system components that facilitate receiving and issuing electronic instructions, storing instructions, data and information, communicating with other devices, display devices, input devices, output devices and the like. For example, power plant controller 19 can include power supply 100, memory 102, processor 104, control circuit 106 and the like. Power plant controllers 19A, 19B and 19C can be configured similarly to controller 19.

Circuit 80 can comprise any suitable computer architecture such as microprocessors, chips and the like that allow memory 84, processor 86, input device 88, output device 90 and communication interface 92 to operate together. Power supply 82 and power supply 100 can comprise any suitable method for providing electrical power to controller 15 and controller 19, respectively, such as AC or DC power supplies. Memory 84 and memory 102 can comprise any suitable memory devices, such as random access memory, read only memory, flash memory, magnetic memory and optical memory. Input device 88 can comprise a keyboard, mouse, pointer, touchscreen and other suitable devices for providing a user input or other input to circuit 80 or memory 84. Output device 90 can comprise a display monitor, a viewing screen, a touch screen, a printer, a projector, an audio speaker and the like. Communication interface 92 can comprise devices for allowing circuit 80 and controller 15 to receive information from and transmit information to other computing devices, such as a modem, a router, an I/O interface, a bus, a local area network, a wide area network, the internet and the like.

Controller 15 can be configured to operate grid 14 and, as such, can be referred to the “home office” for power system 10. Grid 14 can comprise power plants 12A, 12B and 12C, as well as power plants 46A, 46B and 46C, high voltage transmission lines that carry power from distant sources to demand centers, and distribution lines that connect end users 30. As mentioned, power grids can be configured to operate at a control frequency where all power input into the grid from disparate sources in input at the same frequency to facilitate integration of the power. In an example, grid 14 can operate at a control frequency of 60 Hertz (Hz).

Controller 15 can determine the demand being placed on grid 14, such as by monitoring the consumption of end users 30. Controller 15 can coordinate generation of power from power plants 12A, 12B and 12C (FIG. 1), as well as power plants 46A, 46B and 46C. That is, controller 15 can assign or instruct each of power plants 12A, 12B, 12C, 46A, 46B and 46C how much power output they should contribute to grid 14, and such assignment may be dynamic and reactive based upon the capabilities and availability of any of the power plants 12A, 12B, 12C, 46A, 46B and 46C. Controller 15 can ensure that the total power generated by power plants 12A, 12B, 12C, 46A, 46B and 46C meets the power demand of end users 30. If power demand of end users 30 exceeds or is less than power supplied by power plants 12A, 12B, 12C, 46A, 46B and 46C, controller 15 can dictate response strategies for each of power plants 12A, 12B, 12C, 46A, 46B and 46C. For example, in the event of a power demand increase that exceeds the predicted operating band, controller 15 can ensure that each of power plants 12A, 12B, 12C, 46A, 46B and 46C responds so that only one or less than all of the power plants is prevented from bearing the burden of generating power for the deficiency. Thus, controller 15 can interface with a power plant controller for each of power plants 12A, 12B, 12C, 46A, 46B and 46C, like controller 19 for power plant 12A.

Circuit 80 can communicate with, that is, read from and write to, a memory device such as memory 84. Memory 84 can include various computer readable instructions for implementing operation of grid 14. Thus, memory 84 can include instructions for monitoring demand on and power being supplied to grid 14. Circuit 80 can be connected to various sensors to perform such functions. Memory 84 can also include information that can assist controller 15 in providing instruction to power plant controller 19 and controllers 19A, 19B and 19C. For example, memory 84 can include power-plant-specific information for each of power plants 12A, 12B, 12C, 46A, 46B and 46C, such as the type, size (capacity), age, maintenance history, location, the location within the geography covered by grid 14, and proximity to end users 30 of each of power plants 12A, 12B, 12C, 46A, 46B and 46C. Memory 84 can also include instructions for determining the percentage of each of power plants 12A, 12B, 12C, 46A, 46B and 46C contribution to the total power supply.

Controller 19 can be configured to operate power plant 12A. As mentioned, power plants 12B and 12C can be configured to operate with similar controllers as controller 19, but illustration and description is omitted. Likewise, controllers 19A, 19B and 19C can be configured to operate similarly as controller 19, including the inclusion of memory 102. Memory 102 can include various computer readable instructions for implementing operation of power plant 12A. Thus, memory 102 can include instructions for monitoring a power generation assignment from controller 15, instructions for power generation for each of engine controllers 24A and 24B, droop responses and imbalance responses for each of generator units 16A and 16B and the like. Memory 102 can also include information that can assist controller 19 in responding to imbalance requests from controller 15, such as they type, size (capacity), age, maintenance history and location for each of gas turbines 20A and 20B.

Additionally, memory 102 can include operational efficiency and effectiveness information, such as productive and economical effectiveness information for each of generator units 16A and 16B, including gas turbines 20A and 20B. For example, memory 102 can include the electrical production efficiency of each of turbines 20A and 20B such as, for example, is illustrated in FIG. 2. Memory 102 can include economical information such as maintenance and economical history for each of gas turbines 20A and 20B such as, for example, is illustrated in FIG. 3, which can also include time since last service, repair, overhaul, refurbishment status, etc. Memory 102 can also include information relating to operational efficiency and effectiveness of power plant 12A including the financial efficiency of each of gas turbines 20A and 20B, such as various contractual obligations for operators of power plant 12A and manufacturers of and service providers for gas turbines 20A and 20B. For example, operators of power plant 12A can have a Long Term Service Agreement (LTSA) for each of gas turbines 20A and 20B. The LTSA can sometimes require the manufacturer to provide, without fee to the power plant operator, routine maintenance, including parts and labor. There can, however, be restrictions placed on the operation of the gas turbines. For example, if the gas turbines are operated above an effective economical hours limit, an actual economical hours limit, above a threshold number of starts and stops, or operated above a temperature threshold for an hours limit (effective economical hours can be calculated, for example, from actual economical hours and number of hours operated above the temperature threshold), the fee arrangement can include charges to the power plant operator. For example, the power plant operator can be required under the LTSA to make higher payments, additional payments, penalty payments or the like. Memory 102 can also include power-plant-specific information for each of power plants 12A, 12B and 12C, as well as power plants 46A, 46B and 46C, such as the type, size (capacity), age, maintenance history, location, the location within the geography covered by grid 14, and proximity to end users 30 of each of power plants 12A, 12B, 12C, 46A, 46B and 46C.

Controller 19 can receive notifications of changes in steady state operation of power system 10 from controller 15. Controller 19 can also directly monitor operation of grid 14 to detect power demand and load imbalances, using sensors or other components and systems. In either configuration, controller 15 can be indirectly or directly monitoring power demand and detecting load imbalance conditions.

In response to steady state operating conditions or load imbalance conditions, controller 19 can issue instructions to, and receive inputs from engine controllers 24A and 24B of gas turbines 20A and 20B. For example, controller 19 can issue start and stop command signals to engine controllers 24A and 24B. Engine controllers 24A and 24B can activate an electric or pneumatic starter motor to rotate turbine shaft 42A, and operate fuel injectors 94 to provide fuel to combustors 38A and 38B, as well as operate an ignitor to begin the combustion process. Engine controllers 24A and 24B can increase or decrease the power output by controlling the combustion process, such as by providing more or less fuel to combustors 38A and 38B with injectors 94 and, if desired, adjustment of variable vanes 96 that can be located in compressors 36A and 36B. Increased or decreased power output of gas turbine 20A and 20B can correspond to increased or decreased speed of shafts 42A and 42B, respectively.

Controller 19 can also issue instructions to engine controllers 24A and 24B for operating gas turbines 20A and 20B in response to a load imbalance on grid 14. Controller 15 for power system 10 can, in response to determining a load imbalance, issue instructions or power generation assignments to power plants 12A, 12B and 12C. The load imbalance instructions can require that each power plant increase or decrease power generation for a fixed or variable length of time. Thus, controller 19 can issue power generation instructions to engine controllers 24A and 24B, and engine controllers 24A and 24B can issue operating instructions to gas turbines 20A and 20B to produce the assigned power generation. These instructions can include increasing or decreasing the power output by controlling the combustion process within combustors 38A and 38B with injectors 94 and variable vanes 96, thereby also resulting in a change in the speed of shafts 42A and 42B. As discussed herein, power plant controllers 19, 19A, 19B and 19C can use power-plant-specific data stored in memory 102 or obtained elsewhere, such as from controller 15, to incongruently operate power plant 12A relative to power plants 12B, 12C, 46A, 46B and 46C during a load imbalance response to provide operation that increases the operational benefit of power plant 12A or the home office of grid 14. The operational benefit can be in the form of, for example, a decrease in maintenance fees due to avoidance of penalty charged or a decrease in fuel consumption resulting from more efficient total mechanical operation of gas turbines 20A and 20B.

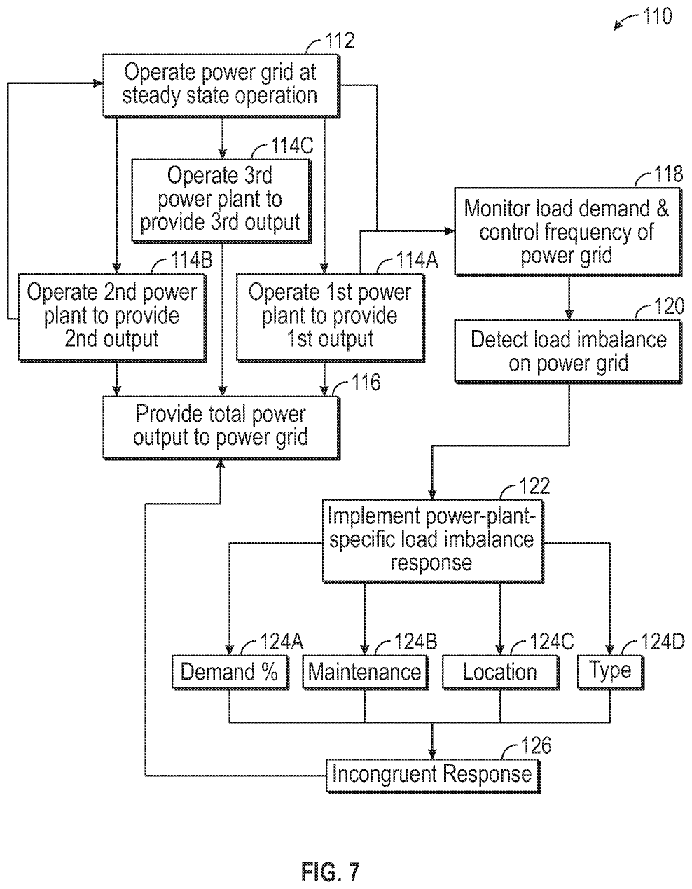

FIG. 7 is a line diagram illustrating steps of method 110 for providing incongruent load imbalance responses for plants 12A, 12B and 12C. Method 110 can also be used for operating power plants 46A, 46B and 46C in addition to or alternatively to power plants 12A, 12B and 12C, though description is provided with reference to power plants 12A, 12B and 12C for simplicity. At step 112, a power grid, such as power grid 14, can operate in a steady state condition. That is, each of power plants 12A, 12B and 12C can operate their respective power generation equipment at a predicted, assigned output to meet expected demand from end users 30 that typically varies within a known band that can be readily accommodated by power plants 12A, 12B and 12C without load rebalancing. At step 112, each controller 19 for power plants 12A, 12B and 12C can control and monitor the operation of generator units 16A and 16B. Likewise, controller 15 can monitor the input of each of power plants 12A, 12B and 12C into grid 14.

At steps 114A, 114B and 116C, controllers 19 for power plants 12A, 12B and 12C can receive their assigned load demand from controller 15 and issue corresponding instructions, e.g., power output command signals, respectively. For example, controller 19 for power plant 12A can issue instructions for operation of gas turbines 20A and 20B such that engine controllers 24A and 24B can issue appropriate fuel, air and speed instructions to gas turbines 20A and 20B to achieve the desired electrical output from generators 22A and 22B, respectively. Thus, at step 116, power plants 12A, 12B and 12C can provide the assigned power output from controller 15 to grid 14.

At step 118, controller 15 and controller 19 for power plant 12A can monitor grid 14. Controllers 19 for power plants 12B and 12C can also monitor grid 14, but illustration and description is omitted for simplicity. Controller 15 for power system 10 can read the total load demand on grid 14 from end users 30. Controller 15 can reference information, such as information stored in memory 84 including power-plant-specific traits of power plants 12A, 12B and 12C, to evaluate the capacity, effectiveness, efficiency and location of power plants 12A, 12B and 12C to determine how to divide the total load demand between power plants 12A, 12B and 12C to provide steady state operating instructions to controllers 19 for power plants 12A, 12B and 12C.

At step 118, controller 15 and controller 19 can continue to monitor steady state operation of power system 10, monitoring output of power plants 12A, 12B and 12C and demand from end users 30. At step 120, controller 15 and controller 19 can detect a load imbalance on grid 14. As discussed, examples of load imbalance can include a sudden, significant demand drop or demand increase from end users 30, or a sudden output drop from one or more of power plants 12A, 12B and 12C. Other examples of load imbalance can include long term load readjustments for grid 14. In response to detecting a load imbalance, controller 15 can issue imbalance response instructions to each of power plants 12A, 12B and 12C. As described herein, controller 15 can issue incongruent droop responses specific to each of power plants 12A, 12B and 12C based on power-plant-specific trait data stored in memory 84 and memory 102. For example, controller 19 for power plant 12A can receive the imbalance response and take appropriate action. In other examples, controller 15 can issue load rebalancing instructions to power plants 12A, 12B and 12C such as in a load down or load up situation where total power to grid 14 is changed for long term durations. Likewise, controller 19 can determine an imbalance response based on information stored in memory 102, such as power-plant-specific trait data regarding operation of power plant 12A relative to power plants 12B and 12C.

At step 122, one or both of controller 15 and controller 19 can implement a power-plant-specific load imbalance response. In one embodiment, controller 15 issues incongruent imbalance response instructions to each of power plants 12A, 12B and 12C that is most operationally effective for grid 14. That is, different imbalance response instructions can be issued to each of power plants 12A, 12B and 12C based on power-plant-specific traits determined by controller 15. For example, controller 19 can determine how much of the total grid demand is being provided by power plant 12A, a maintenance state of power plant 12A, how close power plant 12A is to end users 30, and the type of power being generated by power plant 12A. Controller 19 can additionally determine those power-plant-specific traits for power plants 12B and 12C. The effectiveness determination can be evaluated based on instantaneous, real-time operating conditions of power plants 12A, 12B and 12C. That is, for example, demand percentages, maintenance states, locations and generation types can be considered, such as is discussed with reference to FIGS. 2 and 3. Other non-real-time factors can be considered, such as engine model and power plant type, etc. Additionally or alternatively, each controller 19 for power plants 12A, 12B and 12C can determine an appropriate power-plant-specific action to meet that imbalance response that is most economically efficient for grid 14. That is, different imbalance response instructions can be executed by each of power plants 12A, 12B and 12C based on power-plant-specific traits determined by each of controllers 19 for each respective power plant.

The remainder of FIG. 7 is discussed with reference to a droop response to a sudden short term output drop by a power plant, but the imbalance responses discussed can apply to load rebalancing instructions for long term readjustment of grid 14.

At step 124A, controller 19 can execute a total grid demand percentage droop response. At step 124B, controller 19 can execute a maintenance condition droop response. At step 124C, controller 19 can execute a location-based droop response. At step 124D, controller 19 can execute a power generation type droop response. For any droop response, at step 126, controller 19 can provide a response to the load imbalance indicated by the shift of the instantaneous grid frequency away from the control frequency. In other examples, controller 19 can provide a response to a load imbalance resulting from a controlled load up or load down situation for longer term adjustments of total power production for grid 14.

In a total grid demand percentage droop response at step 124A, controller 19 can operate whichever of power plants 12A, 12B and 12C that is most effective at preventing oscillations in addressing the load imbalance. For example, if power plant 12A is configured to contribute a greater percentage of the total grid demand to grid 14, power plant 12A can be operated with an increased droop response percentage to provide a smaller than typical droop response in order to reduce overshoot.

In a maintenance condition droop response at step 124B, controller 19 can operate power plants 12A, 12B and 12C to more effectively utilize available electrical generator resources. For example, controller 19 can provide a different droop response depending on the number of electrical generators that are online, e.g., not down for maintenance. If all electrical generators are online, then the droop response may be provided consistent with the power-plant-specific traits described herein, such as a maintenance condition droop response at step 124B, a location-based droop response at step 124C or a power generation type droop response at step 124D. If one or more electrical generators are offline, then the droop response percentage may be maintained at the typical level, rather than being increased to reduce overshoot as described above.

In a location-based droop response at step 124C, controller 19 can operate whichever of power plants 12A, 12B and 12C that is most effective at transmitting power to end users 30. For example, power plants that are closer to end users 30 can reduce their droop response percentage compared to the typical level in order to provide more power to address the load imbalance.

In a power generation type droop response at step 124D, controller 19 can operate whichever of power plants 12A, 12B and 12C that is most effective at responding to the load imbalance in a timely manner. For example, power plants that utilize gas turbines as prime movers are very responsive, e.g., quick to increase electrical output, can reduce their droop response percentage compared to the typical level in order to provide more power to address the load imbalance.

At step 126, an incongruent turbine droop response can be implemented. For example, instructions from controller 19 can be issued to engine controller 24A in response to the actual, instantaneous frequency of grid 14 deviating from the control frequency. Likewise, controllers 19 of power plants 12B and 12C can operate to provide droop responses that are either consistent with the typical droop response level determined by the home office, or can implement their own power-plant-specific droop response as described herein.

In any event, grid 14 will receive a total droop response that may be above, at, or below the typical drop response, but which will provide grid 14 with a more effective allocation of resources that can prevent overshoot (overcompensation), reduce oscillations, and prevent grid 14 from implementing other load imbalance responses, such as load shedding or rolling blackouts which undesirably cause some or all of end users 30 to lose power.

The systems and methods discussed in the present application can be useful in increasing operational benefit of electrical power producers, either at the grid level or the power plant level. Utilizing the power-plant-specific traits and droop responses described herein, operational benefits can be achieved that include providing more responsive droop responses that more quickly provide additional power to the grid to address load imbalances and prevent outages, or providing less robust droop responses that provide adequate power to the grid to address load imbalances without causing overshoot. The power-plant-specific droop responses can be implemented in short term and long term imbalance situations. Short term load imbalance situations can include “droop responses” that occur as a result of sudden changes in power demand from the grid at a steady state operating condition, and long term load imbalance situations can include “load changes” that occur as a result of a planned transition period from a first steady state operating condition to a second different steady state operating condition.

### VARIOUS NOTES & EXAMPLES

Example 1 can include or use subject matter such as a method of controlling an imbalance response in a power grid comprising a first power plant and a second power plant, the method can comprise: monitoring operation of the first power plant while operating at a first level to provide a first power output, monitoring operation of the second power plant while operating at a second level to provide a second power output, monitoring load demand from the power grid operating at a steady state condition, detecting a load imbalance on the power grid that causes a deviation from the steady state condition, and issuing incongruent load imbalance instructions to the first power plant and the second power plant to provide a load imbalance response to change the first power output and the second power output to reduce the deviation from the steady state condition depending on a power-plant-specific trait of each of the first power plant and the second power plant.

Example 2 can include, or can optionally be combined with the subject matter of Example 1, to optionally include a steady state condition that can comprise a control frequency, the first power plant and the second power plant being configured to operate at the control frequency in the steady state condition, and the load imbalance that can comprise a deviation from the control frequency.

Example 3 can include, or can optionally be combined with the subject matter of one or any combination of Examples 1 or 2 to optionally include the load imbalance response comprising adjusting at least one of the first power output and the second power output to reduce the deviation.

Example 4 can include, or can optionally be combined with the subject matter of one or any combination of Examples 1 through 3 to optionally include the load imbalance response comprising changing a droop response of at least one of the first power plant and the second power plant to accommodate the load imbalance.

Example 5 can include, or can optionally be combined with the subject matter of one or any combination of Examples 1 through 4 to optionally include the power-plant-specific trait comprising a total grid demand percentage of each power plant, and the first power plant has a first grid demand percentage and the second power plant has a second grid demand percentage.

Example 6 can include, or can optionally be combined with the subject matter of one or any combination of Examples 1 through 5 to optionally include the load imbalance response comprising: increasing a droop response percentage for a power plant having a larger of the first grid demand percentage and the second grid demand percentage in a power outage condition.

Example 7 can include, or can optionally be combined with the subject matter of one or any combination of Examples 1 through 6 to optionally include the load imbalance response comprising: maintaining a droop response percentage for a power plant having a smaller of the first grid demand percentage and the second grid demand percentage in the power outage condition.

Example 8 can include, or can optionally be combined with the subject matter of one or any combination of Examples 1 through 7 to optionally include the load imbalance response comprising: increasing a droop response percentage for a power plant having a smaller of the first grid demand percentage and the second grid demand percentage in a power outage condition.

Example 9 can include, or can optionally be combined with the subject matter of one or any combination of Examples 1 through 8 to optionally include the power-plant-specific trait comprising a location of each power plant, and the first power plant having a first location located a first distance from power consumers of the power grid and the second power plant having a second location located a second distance from the power consumers of the power grid.

Example 10 can include, or can optionally be combined with the subject matter of one or any combination of Examples 1 through 9 to optionally include the load imbalance response comprising increasing a droop response percentage of a power plant having a larger of the first distance and the second distance in a power outage condition.

Example 11 can include, or can optionally be combined with the subject matter of one or any combination of Examples 1 through 10 to optionally include the power-plant-specific trait comprising a capacity type of each power plant, and the first power plant having a first capacity type with a first responsiveness and the second power plant having a second capacity type with a second responsiveness.

Example 12 can include, or can optionally be combined with the subject matter of one or any combination of Examples 1 through 11 to optionally include the load imbalance response comprising decreasing a droop response percentage for a power plant having a larger of the first responsiveness and the second responsiveness in a power outage condition.

Example 13 can include, or can optionally be combined with the subject matter of one or any combination of Examples 1 through 12 to optionally include the power-plant-specific trait comprising a repair state of each power plant, the load imbalance response comprising: comparing the repair state of the first power plant and the repair state of the second power plant, and reducing a droop response percentage for the power plant having the repair state that indicates a reduced capacity to respond to the imbalance.

Example 14 can include or use subject matter such as a method of controlling operation of a first power plant in response to changing power grid conditions can comprise: receiving a power-plant-specific power assignment from an operator of a grid system, monitoring an operating frequency of the power grid relative to a control frequency, operating at least one power generator of the first power plant at the control frequency to provide a local power output to meet the power-plant-specific power assignment under steady state conditions, detecting a load imbalance from the power grid wherein the operating frequency and the control frequency are different, and operating the at least one power generator to provide a power-plant-specific imbalance response wherein the local power output is adjusted based on a power-plant-specific-trait of the first power plant relative to a second power plant working with the operator.

Example 15 can include, or can optionally be combined with the subject matter of Example 14, to optionally include the power-plant-specific trait comprising a percentage of a total power demand of the grid system contributed by the local power output.

Example 16 can include, or can optionally be combined with the subject matter of one or any combination of Examples 14 or 15 to optionally include the power-plant-specific imbalance response comprising increasing a droop response percentage of the first power plant when a percentage of the total power demand of the first power plant is greater than a percentage of the total power demand of the second power plant.

Example 17 can include, or can optionally be combined with the subject matter of one or any combination of Examples 14 through 16 to optionally include the power-plant-specific trait comprising a distance of the first power plant from power consumers of the grid system.

Example 18 can include, or can optionally be combined with the subject matter of one or any combination of Examples 14 through 17 to optionally include the plant-specific imbalance response comprising increasing a droop response percentage of the first power plant when a distance of the first power plant from the power consumers is greater than a distance of the second power plant from the power consumers.

Example 19 can include, or can optionally be combined with the subject matter of one or any combination of Examples 14 through 18 to optionally include the power-plant-specific trait comprising a responsiveness of the at least one power generator of the first power plant.

Example 20 can include, or can optionally be combined with the subject matter of one or any combination of Examples 14 through 19 to optionally include the power-plant-specific imbalance response comprising decreasing a droop response percentage of the first power plant when a responsiveness of the at least one power generator of the first power plant is greater than a responsiveness of a generator of the second power plant.

Example 21 can include, or can optionally be combined with the subject matter of one or any combination of Examples 14 through 20 to optionally include the power-plant-specific trait comprising a repair state of the first power plant.

Example 22 can include, or can optionally be combined with the subject matter of one or any combination of Examples 14 through 21 to optionally include the power-plant-specific imbalance response comprising reducing a droop response percentage of the first power plant when the first power plant has less capacity down for repair than the second power plant.

Example 23 can include or use subject matter such as a control system for operating a power plant can comprise: a power plant controller for controlling at least one power generator at a facility, the power plant controller can comprise: a power generator interface for providing control input signals to the at least one power generator to control output of at least one electrical generator, a grid interface for receiving a control frequency at which a power grid is to be operated, and a current operating frequency of the power grid, and memory having stored therein power-plant-specific data for the power plant relative to other power plants of the power grid, wherein the power plant controller is configured to adjust a droop response of the power plant incongruently relative to the other power plants based on the power-plant-specific data in response to the current operating frequency deviating from the control frequency.

Example 24 can include, or can optionally be combined with the subject matter of Example 1, to optionally include the power-plant-specific data being provided by a power system controller for the power grid.

Example 25 can include, or can optionally be combined with the subject matter of one or any combination of Examples 23 or 24 to optionally include the power-plant-specific data being generated by the power plant controller.

Example 26 can include, or can optionally be combined with the subject matter of one or any combination of Examples 23 through 25 to optionally include the power-plant-specific data comprising location data of the power plant relative to power consumers of the power grid.

Example 27 can include, or can optionally be combined with the subject matter of one or any combination of Examples 23 through 26 to optionally include the power-plant-specific data comprising a percentage of total grid power demand supplied by the power plant.

Example 28 can include, or can optionally be combined with the subject matter of one or any combination of Examples 23 through 27 to optionally include the power-plant-specific data comprising a responsiveness of the at least one electrical generator of the power plant.

Each of these non-limiting examples can stand on its own, or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A method of controlling an imbalance response in a power grid comprising a first power plant and a second power plant, the method comprising:
monitoring operation of the first power plant while operating at a first level to provide a first power output;
monitoring operation of the second power plant while operating at a second level to provide a second power output;
monitoring load demand from the power grid operating at a steady state condition;
detecting a load imbalance on the power grid that causes a deviation from the steady state condition; and
issuing incongruent load imbalance instructions to the first power plant and the second power plant to provide a load imbalance response to change the first power output and the second power output to reduce the deviation from the steady state condition depending on a power-plant-specific trait of each of the first power plant and the second power plant.

2. The method of claim 1, wherein:
the steady state condition comprises a control frequency;
the first power plant and the second power plant are configured to operate at the control frequency in the steady state condition; and
the load imbalance comprises a deviation from the control frequency.

3. The method of claim 1, wherein the load imbalance response comprises adjusting at least one of the first power output and the second power output to reduce the deviation.

4. The method of claim 1, wherein the load imbalance response comprises changing a droop response of at least one of the first power plant and the second power plant to accommodate the load imbalance.

5. The method of claim 1, wherein the power-plant-specific trait comprises a total grid demand percentage of each power plant, and the first power plant has a first grid demand percentage and the second power plant has a second grid demand percentage.

6. The method of claim 5, wherein the load imbalance response comprises:
increasing a droop response percentage for a power plant having a larger of the first grid demand percentage and the second grid demand percentage in a power outage condition.

7. The method of claim 6, wherein the load imbalance response comprises:
maintaining a droop response percentage for a power plant having a smaller of the first grid demand percentage and the second grid demand percentage in the power outage condition.

8. The method of claim 5, wherein the load imbalance response comprises:
increasing a droop response percentage for a power plant having a smaller of the first grid demand percentage and the second grid demand percentage in a power outage condition.

9. The method of claim 1, wherein the power-plant-specific trait comprises a location of each power plant, and the first power plant has a first location located a first distance from power consumers of the power grid and the second power plant has a second location located a second distance from the power consumers of the power grid.

10. The method of claim 9, wherein the load imbalance response comprises:
increasing a droop response percentage of a power plant having a larger of the first distance and the second distance in a power outage condition.

11. The method of claim 1, wherein the power-plant-specific trait comprises a capacity type of each power plant, and the first power plant has a first capacity type with a first responsiveness and the second power plant has a second capacity type with a second responsiveness.

12. The method of claim 11, wherein the load imbalance response comprises:
decreasing a droop response percentage for a power plant having a larger of the first responsiveness and the second responsiveness in a power outage condition.

13. The method of claim 1, wherein:
the power-plant-specific trait comprises a repair state of each power plant;
the load imbalance response comprises:
comparing the repair state of the first power plant and the repair state of the second power plant; and
reducing a droop response percentage for the power plant having the repair state that indicates a reduced capacity to respond to the imbalance.

14. A method of controlling operation of a first power plant in response to changing power grid conditions, the method comprising:
receiving a power-plant-specific power assignment from an operator of a grid system;
monitoring an operating frequency of the power grid relative to a control frequency;
operating at least one power generator of the first power plant at the control frequency to provide a local power output to meet the power-plant-specific power assignment under steady state conditions;
detecting a load imbalance from the power grid wherein the operating frequency and the control frequency are different; and
operating the at least one power generator to provide a power-plant-specific imbalance response wherein the local power output is adjusted based on a power-plant-specific-trait of the first power plant relative to a second power plant working with the operator.

15. The method of claim 14, wherein the power-plant-specific trait comprises a percentage of a total power demand of the grid system contributed by the local power output.

16. The method of claim 15, wherein the power-plant-specific imbalance response comprises increasing a droop response percentage of the first power plant when a percentage of the total power demand of the first power plant is greater than a percentage of the total power demand of the second power plant.

17. The method of claim 14, wherein the power-plant-specific trait comprises a distance of the first power plant from power consumers of the grid system.

18. The method of claim 17, wherein the power-plant-specific imbalance response comprises increasing a droop response percentage of the first power plant when a distance of the first power plant from the power consumers is greater than a distance of the second power plant from the power consumers.

19. The method of claim 14, wherein the power-plant-specific trait comprises a responsiveness of the at least one power generator of the first power plant.

20. The method of claim 19, wherein the power-plant-specific imbalance response comprises decreasing a droop response percentage of the first power plant when a responsiveness of the at least one power generator of the first power plant is greater than a responsiveness of a generator of the second power plant.

21. The method of claim 14, wherein the power-plant-specific trait comprises a repair state of the first power plant.

22. The method of claim 21, wherein the power-plant-specific imbalance response comprises reducing a droop response percentage of the first power plant when the first power plant has less capacity down for repair than the second power plant.

23. A control system for operating a power plant, the control system comprising:
a power plant controller for controlling at least one power generator at a facility, the power plant controller comprising:
a power generator interface for providing control input signals to the at least one power generator to control output of at least one electrical generator;
a grid interface for receiving a control frequency at which a power grid is to be operated, and a current operating frequency of the power grid; and
memory having stored therein power-plant-specific data for the power plant relative to other power plants of the power grid;
wherein the power plant controller is configured to adjust a droop response of the power plant incongruently relative to the other power plants based on the power-plant-specific data in response to the current operating frequency deviating from the control frequency.

24. The control system of claim 23, wherein the power-plant-specific data is provided by a power system controller for the power grid.

25. The control system of claim 23, wherein the power-plant-specific data is generated by the power plant controller.

26. The control system of claim 23, wherein the power-plant-specific data comprises location data of the power plant relative to power consumers of the power grid.

27. The control system of claim 23, wherein the power-plant-specific data comprises a percentage of total grid power demand supplied by the power plant.

28. The control system of claim 23, wherein the power-plant-specific data comprises a responsiveness of the at least one electrical generator of the power plant.
